(19) United States
(12) Patent Application Publication
(10) Pub. No.: US 2018/0295094 A1
(43) Pub. Date: Oct. 11, 2018

(54) REDUCING LATENCY DURING DOMAIN NAME RESOLUTION IN NETWORKS

(71) Applicant: LinkedIn Corporation, Sunnyvale, CA (US)

(72) Inventors: Russell I. White, Apex, NC (US); Shafagh Zandi, San Francisco, CA (US)

(73) Assignee: LinkedIn Corporation, Sunnyvale, CA (US)

(21) Appl. No.: 15/480,252

(22) Filed: Apr. 5, 2017

(51) Int. Cl. H04L 29/12; H04L 29/08

(52) U.S. Cl. CPC H04L 61/1511; H04L 67/22; H04L 67/2833; H04L 67/2842; H04L 67/142

(57) ABSTRACT

The disclosed embodiments provide a system that performs domain name resolution. During operation, the system uses one or more attributes of a Domain Name System (DNS) query to identify a membership of the DNS query in a grouping of related DNS queries. Next, the system obtains a set of DNS records for resolving the related DNS queries. The system then expedites resolution of subsequent DNS queries in the grouping by transmitting the set of DNS records in a response to the DNS query.

### BACKGROUND

### Field

The disclosed embodiments relate to domain name resolution. More specifically, the disclosed embodiments relate to techniques for reducing latency during domain name resolution in networks.

### Related Art

Web performance is important to the operation and success of many organizations. In particular, a company with an international presence may provide websites, web applications, mobile applications, databases, content, and/or other services or resources through multiple data centers around the globe. Thus, slow or disrupted access to a service or a resource may potentially result in lost business for the company and/or a reduction in consumer confidence that results in a loss of future business. For example, high latency in loading web pages from the company's website may negatively impact the user experience with the website and deter some users from returning to the website.

During access to websites, web applications, and/or other web-based services or resources, the Domain Name System (DNS) is frequently used to translate human-friendly host names into numeric Internet Protocol (IP) addresses that can be used to locate and identify the corresponding network services using underlying network protocols. As a result, users may reach the services by providing meaningful Uniform Resource Locators (URLs) and email addresses instead of memorizing numeric addresses and/or understanding the underlying mechanisms for locating the services.

However, multiple DNS name-to-address mappings are typically required to access a single service or resource. For example, loading of a single web page may require contacting tens or hundreds of servers and/or other components providing advertisements, images, fonts, tracking, and/or other content or features in the web page. At the same time, each component may have a domain name that requires a sequence of queries to multiple DNS servers to resolve. Consequently, querying of multiple related domain names during access to a single service or resource may contribute significantly to web and/or network latency.

### BRIEF DESCRIPTION OF THE FIGURES

FIG. 1 shows a system for performing domain name resolution in accordance with the disclosed embodiments.

FIG. 2 shows the resolution of domain names in accordance with the disclosed embodiments.

FIG. 3 shows a flowchart illustrating a process of performing domain name resolution in a network in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

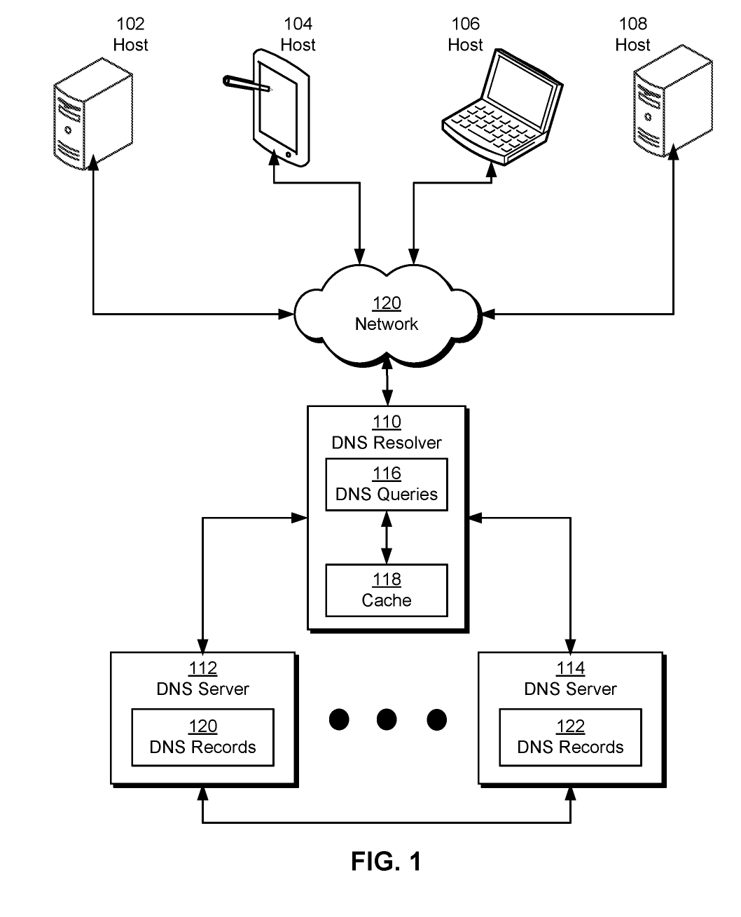

The disclosed embodiments provide a method, apparatus, and system for performing domain name resolution in networks. More specifically, the disclosed embodiments provide a method, apparatus, and system for reducing latency during domain name resolution. As shown in FIG. 1, resolution of domain names over a network 120 may be performed by a domain name system (DNS) resolver 110 that processes DNS queries 116 and a set of DNS servers 112-114 that interface with DNS resolver 110 to resolve DNS queries 116.

Hosts 102-108 may be personal computers (PCs), laptop computers, tablet computers, mobile phones, portable media players, servers, workstations, gaming consoles, and/or other computing devices that are reachable over network 120. To enable access to services or resources over network 120, an instance of DNS resolver 110 may execute on each host and resolve Uniform Resource Locators (URLs), email addresses, and/or other human-friendly domain names into Internet Protocol (IP) addresses that can be used by underlying network protocols to locate and identify the corresponding services or resources. For example, DNS resolver 110 may be used to locate a collection of servers that provide advertisements, tracking services, text, fonts, images, audio, video, and/or other components of a web page accessed by the host. In another example, DNS resolver 110 may identify a mail server that can be used to accept email messages from the host to a recipient domain.

DNS resolver 110 may initiate and/or perform a sequence of DNS queries 116 with DNS servers 112-114 to retrieve one or more DNS records 120-122 that are used to resolve a given domain name. For example, DNS resolver 110 may query a root server for a DNS record containing an address of a top-level domain (TLD) name server associated with the domain name. DNS resolver 110 may query the TLD name server and/or additional DNS servers 112-114 in the DNS hierarchy (e.g., using addresses from DNS records 120-122 received from higher-level DNS servers in the hierarchy) until a DNS record that resolves the domain name is received from an authoritative name server. In another example, DNS resolver 110 may initially query a recursive name server that, in turn, queries other DNS servers 112-114 on behalf of DNS resolver 110 to obtain the DNS record. In a third example, DNS resolver 110 and/or a DNS server queried by DNS resolver 110 may retrieve the DNS record from a cache (e.g., cache 118) instead of performing additional queries with other DNS servers (e.g., DNS servers 112-114).

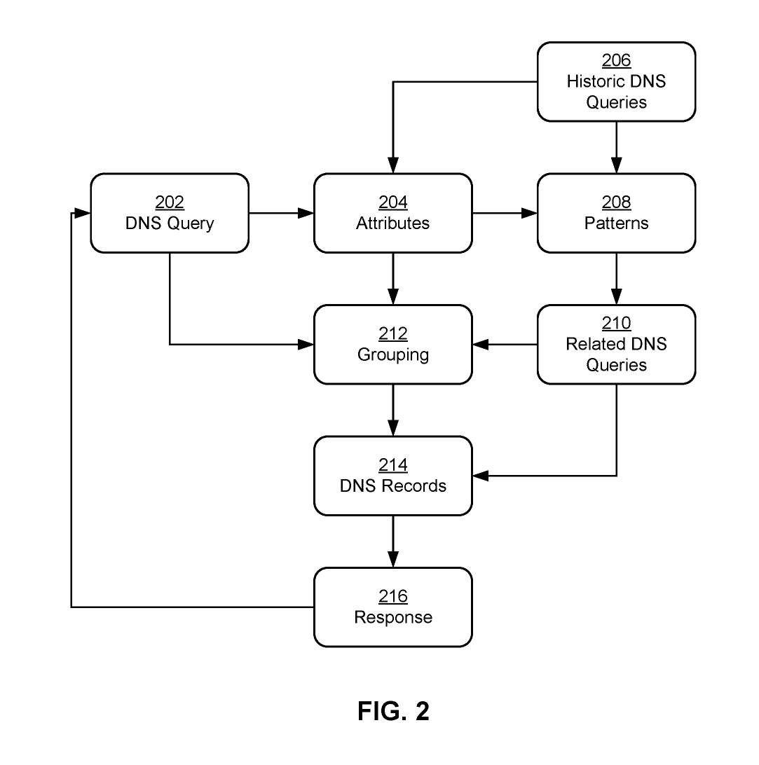

In one or more embodiments, the system of FIG. 1 includes functionality to reduce latency during domain name resolution. As shown in FIG. 2, a component involved in domain name resolution (e.g., DNS resolver 110, DNS servers 112-114) may analyze logs and/or other records of historic DNS queries 206 for patterns 208 associated with related DNS queries 210. Each grouping may include a set of DNS queries identified by attributes 204 that frequently occur together within a pre-specified period (e.g., a span of seconds). For example, groupings of related DNS queries 210 with the same set of domain names may occur during access to various components of a web page and/or use of a specific resource or service. As a result, receipt of a DNS query that is frequently found in a given grouping but infrequently found outside the grouping may be indicative of subsequent receipt of other queries in the grouping by the component.

To establish patterns 208, the component may analyze attributes 204 such as domain names, record types (e.g., A, AAAA, MX, NS, PTR, etc.), and/or timestamps associated with a set of historic DNS queries 206. For example, the component may apply a clustering technique, regression model, artificial neural network, support vector machine, decision tree, random forest, boosted gradient tree, naïve Bayes classifier, ensemble model, and/or other type of statistical model to attributes 204. In turn, the statistical model may identify the groupings as time-based clusters of related DNS queries 210 containing the same set or similar sets of domain names, sets of co-occurring (e.g., within a span of a few to several seconds) DNS queries, and/or other time-based patterns 208 in attributes 204.

The component may also, or instead, detect time-based patterns 208 that reveal groups of related DNS queries 210 by analyzing or aggregating statistics associated with historic DNS queries 206, filtering or grouping historic DNS queries 206, and/or analyzing metrics such as correlation coefficients, co-occurrence probabilities, and/or mutual information associated with two or more historic DNS queries 206. After historic DNS queries 206 are analyzed for groups of related DNS queries 210, the component may store each group of related DNS queries 210 in a database, file, memory, and/or other type of repository or storage mechanism for subsequent retrieval, transmission to other components of the system, and/or use. The component may optionally retrieve and/or cache a set of DNS records 214 that resolve each group of related DNS queries 210 to expedite subsequent resolution of the DNS queries. To ensure that the identified groups of related DNS queries 210 reflect recent DNS querying behavior, each group may be associated with a period of validity and/or time to live (TTL). After the period has elapsed, the group may be deleted, and more recent historic DNS queries 206 may optionally be re-analyzed to identify new groups of related DNS queries 210 and/or verify the continued existence of existing groups of related DNS queries 210.

The component and/or another component of the system may then use related DNS queries 210 to decrease latency during subsequent resolution of domain names. In particular, the component may use one or more attributes 204 of a DNS query 202 to be resolved to determine if DNS query 202 is a member of a given grouping 212 of related DNS queries 210. For example, the component may match the domain name, record type, and/or other attributes 204 of DNS query 202 to groups of related DNS queries 210 identified from historic DNS queries 206. If one or more relevant attributes 204 of DNS query 202 match those of a DNS query in a given grouping 212, the component may identify DNS query 202 as a member of grouping 212.

When DNS query 202 is identified as belonging to a grouping (e.g., grouping 212) of related DNS queries 210, the component may obtain a set of DNS records 214 for resolving all queries in the grouping. For example, the component may retrieve DNS records 214 from a local database or cache, such as cache 118 of FIG. 1. The component may also, or instead, query one or more DNS servers (e.g., DNS servers 112-114 of FIG. 1) for DNS records 214 that resolve related DNS queries 210, including a DNS record for resolving DNS query 202. After the component has retrieved DNS records 214, the component may transmit all DNS records 214 in a response 216 to DNS query 202. In turn, the recipient of the response may use DNS records 214 to access the corresponding services and/or hosts (e.g., hosts 102-108 of FIG. 1) instead of separately transmitting DNS queries for individual services and/or hosts and receiving a separate response to each DNS query.

The component may additionally tailor DNS records 214 in response 216 to one or more attributes 204 of DNS query 202. For example, the component may identify DNS query 202 as a request for a AAAA record. In turn, the component may include, in response 216, AAAA records containing IPv6 addresses for resolving the corresponding domain names in grouping 212 instead of A records containing IPv4 addresses that resolve the domain names. In other words, the component may maintain consistency of record types in grouping 212 based on the record type requested in DNS query 202.

To further verify the likelihood that a given query (e.g., DNS query 202) is part of a grouping (e.g., grouping 212) of related DNS queries 210, after receiving the query the component may optionally identify other DNS queries as members of the grouping prior to transmitting DNS records 214 that resolve all related DNS queries 210 in the grouping. For example, the component may initially receive a first DNS query in the grouping and transmit, to the sender of the first DNS query, a response containing a single DNS record that resolves the first DNS query. The component may also update a flag, variable, and/or other data structure with an indication that the first DNS query was received from the sender. Next, the component may receive a second DNS query in the grouping from the same sender. Because the component has now received multiple DNS queries in the grouping from the same sender, the component may establish a significant likelihood that subsequent queries in the grouping will be received from the sender. As a result, the component may return, in a response to the second DNS query, all remaining DNS records required to resolve the remaining DNS queries in the grouping, thereby reducing the time required to perform domain name resolution for the grouping. As mentioned above, DNS records 214 may be cached upon receipt of one or more DNS queries in the grouping and/or after the grouping is identified. In turn, the cached DNS records 214 may enable faster delivery of DNS records 214 upon determining that all queries in the grouping would likely be received.

The component may vary the number of DNS queries in a given grouping (e.g., grouping 212) to be received before DNS records (e.g., DNS records 214) for resolving remaining DNS queries are transmitted in a single response to one of the DNS queries. For example, if a DNS query has a domain name that is included in multiple groupings, the component may delay transmitting a response (e.g., response 216) that aggregates multiple DNS records for resolving a given grouping until additional DNS queries that can be used to more concretely identify the grouping are received from the same sender.

Conversely, the component may use attributes 204 to exclude DNS query 202 from a given grouping 212 of related DNS queries 210. For example, the component may receive, from the same sender, a DNS query for an MX record and a DNS query for an A or AAAA record in close proximity to one another. Because the two DNS queries are for separate record types, the component may rule out the possibility that the DNS queries belong in the same grouping, even if one or more portions of the domain names in the DNS queries overlap. In another example, the component may use one or more subdomains of the domain name in DNS query 202 (e.g., “www”, “ftp”, etc.) to include or exclude DNS query 202 as a member of grouping 212.

By identifying groupings (e.g., grouping 212) of related DNS queries 210 from patterns 208 in historic DNS queries 206 and using the groupings to generate responses (e.g., response 216) containing aggregated DNS records 214 that resolve the related DNS queries, the system may expedite domain name resolution during access to websites, web applications, and/or other services with multiple components. In turn, the system may reduce latency and increase performance associated with loading, accessing, and/or using the services.

Those skilled in the art will appreciate that components of the system may be implemented in a variety of ways. As described above, a DNS resolver, DNS server, and/or other type of query-processing component may be used to identify individual DNS queries (e.g., DNS query 202) as belonging to groupings (e.g., grouping 212) of related DNS queries 210 and transmit responses containing multiple DNS records (e.g., DNS records 214) for resolving the related DNS queries to senders of the DNS queries. Similarly, patterns 208 used to identify groups of related DNS queries 210 may be analyzed from historic DNS queries 206 by the same component or a different component, such as an offline-processing system that performs periodic batch processing of historic DNS queries 206. In turn, the offline-processing system may provide the identified groupings to the query-processing component for subsequent use in expediting the online resolution of domain names in the groupings.

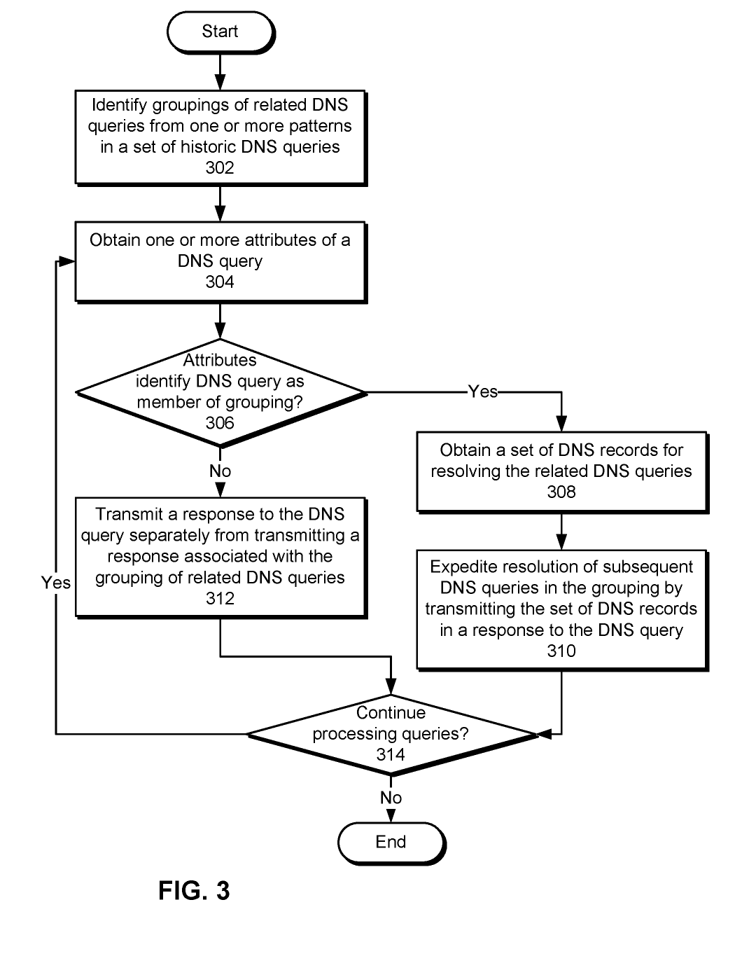

FIG. 3 shows a flowchart illustrating a process of performing domain name resolution in a network in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, groupings of related DNS queries are identified from one or more patterns in a set of historic DNS queries (operation 302). Each grouping may include DNS queries that frequently occur together, such as DNS queries that are generated during loading of a web page and/or service with multiple components. The grouping may be identified using a statistical model and/or statistical analysis technique such as a clustering technique, regression model, artificial neural network, support vector machine, decision tree, random forest, boosted gradient tree, naïve Bayes classifier, and/or ensemble model. The statistical model or statistical analysis technique may detect the grouping as a time-based cluster of related attributes (e.g., domain names, record types, senders, timestamps, etc.) in the historic DNS queries and/or a group of co-occurring (e.g., within a pre-specified interval) DNS queries. The grouping may also, or instead, be identified by analyzing or aggregating statistics associated with the historic DNS queries, filtering or grouping the historic DNS queries, and/or analyzing metrics such as correlation coefficients, co-occurrence probabilities, and/or mutual information associated with two or more historic DNS queries to establish time-based patterns in the historic DNS queries.

Next, one or more attributes of a new DNS query are obtained (operation 304) and used to determine if the DNS query is a member of a grouping (operation 306). For example, the DNS query may be received by a DNS resolver, DNS server, and/or other component involved in performing domain name resolution for a host or client. If the domain name, record type, and/or other relevant attributes of the DNS query match those of a DNS query in the grouping, the component may identify the DNS query as a member of the grouping.

If the DNS query is identified as a member of the grouping, a set of DNS records for resolving the related DNS queries is obtained (operation 308). For example, the DNS records may be obtained from a cache and/or by querying one or more DNS servers for the DNS records. Resolution of subsequent DNS queries in the grouping is then expedited by transmitting the set of DNS records in a response to the DNS query (operation 310). In turn, the host and/or client from which the DNS query was received may use the DNS records to resolve the remaining DNS queries in the grouping without transmitting a separate DNS query for each domain name in the grouping and receiving a separate response to the query. Operations 308-310 may optionally be delayed until multiple DNS queries in the grouping have been received from the same sender (e.g., to further establish that additional DNS queries in the grouping are likely to be received from the sender). For example, an attribute of an additional DNS query from the same sender as the DNS query may be used to identify a membership of the additional DNS query in the grouping prior to transmitting the response to the DNS query.

On the other hand, if the DNS query does not have attributes that match those of any related DNS queries in the grouping, a response to the DNS query is transmitted separately from transmitting a response associated with the grouping of related DNS queries (operation 312). For example, a DNS query may be omitted as a member of the grouping if the record type of the DNS query does not match the record types of the related DNS queries in the grouping, even if one or more portions of the domain name in the DNS query match those of a member in the grouping. As a result, a response to the DNS query may be transmitted separately and lack DNS records used to resolve the related DNS queries in the grouping.

Processing of DNS queries may continue (operation 314). During such query processing, each DNS query received is analyzed for membership in a grouping of related DNS queries (operations 304-306). A response to the DNS query is then generated to include DNS records for resolving remaining DNS queries in the grouping if the DNS query is a member of the grouping (operations 308-310). Conversely, the response may be generated separately from a response for resolving the grouping of related DNS queries (operation 312) if the DNS query is deemed to lack membership in the grouping. Such generation and transmission of responses to DNS queries may be performed as long as the responses are used to reduce latency during resolution of domain names in the groupings.

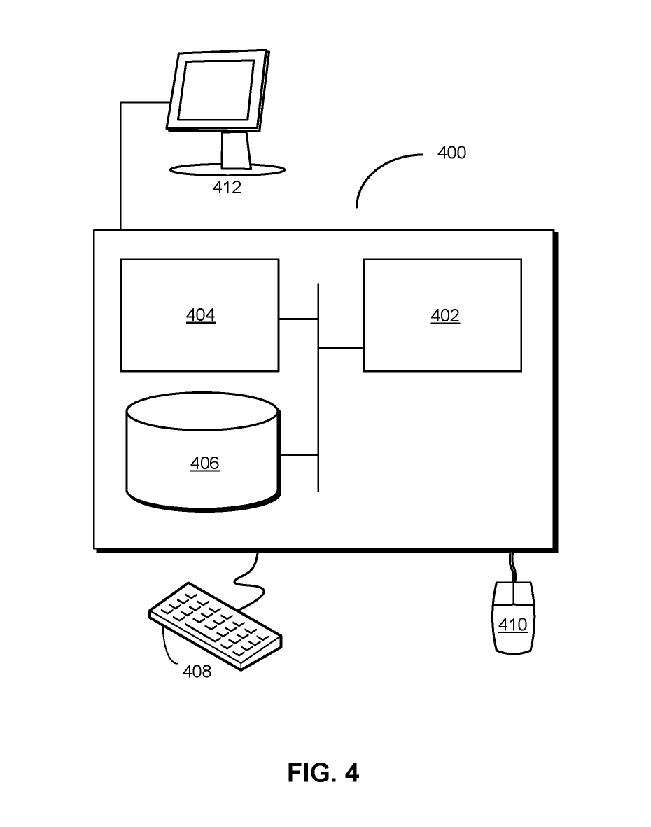

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus and a query-processing apparatus, one or both of which may alternatively be termed or implemented as a module, mechanism, or other type of system component. The analysis apparatus may analyze a set of historic DNS queries to identify groupings of related DNS queries from one or more patterns in the historic DNS queries. Next, the query-processing apparatus may use one or more attributes of a DNS query to identify a membership of the DNS query in a grouping of related DNS queries. The query-processing apparatus may then obtain a set of DNS records for resolving the related DNS queries and expedite resolution of subsequent DNS queries in the grouping by transmitting the set of DNS records in a response to the DNS query.

In addition, one or more components of computer system 400 may be remotely located and connected to the other components over a network. Portions of the present embodiments (e.g., analysis apparatus, query-processing apparatus, DNS resolver, DNS server, etc.) may also be located on different nodes of a distributed system that implements the embodiments. For example, the present embodiments may be implemented using a cloud computing system that performs expedited domain name resolution for a set of remote hosts or clients.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
using one or more attributes of a Domain Name System (DNS) query to identify, by a computer system, a membership of the DNS query in a grouping of related DNS queries;
obtaining, by the computer system, a set of DNS records for resolving the related DNS queries; and
expediting resolution of subsequent DNS queries in the grouping by transmitting the set of DNS records in a response to the DNS query.

2. The method of claim 1, further comprising:
identifying the grouping of related DNS queries from one or more patterns in a set of historic DNS queries.

3. The method of claim 2, wherein identifying the grouping of related DNS queries from one or more patterns in the historic DNS queries comprises:
applying a statistical model to the historic DNS queries to identify the one or more patterns.

4. The method of claim 2, wherein identifying the grouping of related DNS queries from one or more patterns in the historic DNS queries comprises:
identifying a time-based pattern in the grouping of related DNS queries from the historic DNS queries.

5. The method of claim 1, further comprising:
using an attribute of an additional DNS query to identify a non-membership of the additional DNS query in the grouping of related DNS queries; and
transmitting an additional response to the additional DNS query separately from transmitting the response to the DNS query.

6. The method of claim 1, further comprising:
using an attribute of an additional DNS query from a sender of the DNS query to identify a membership of the additional DNS query in the grouping of related DNS queries prior to transmitting the response to the DNS query.

7. The method of claim 1, wherein the grouping of related DNS queries is associated with loading of a web page.

8. The method of claim 1, wherein the computer system is at least one of:
a DNS resolver; and
a DNS server.

9. The method of claim 1, wherein the one or more attributes comprise a domain name.

10. The method of claim 9, wherein the one or more attributes further comprise a record type.

11. An apparatus, comprising:
one or more processors; and
memory storing instructions that, when executed by the one or more processors, cause the apparatus to:
use one or more attributes of a Domain Name System (DNS) query to identify a membership of the DNS query in a grouping of related DNS queries;
obtain a set of DNS records for resolving the related DNS queries; and
expedite resolution of subsequent DNS queries in the grouping by transmitting the set of DNS records in a response to the DNS query.

12. The apparatus of claim 11, wherein the memory further stores instructions that, when executed by the one or more processors, cause the apparatus to:
identify the grouping of related DNS queries from one or more patterns in a set of historic DNS queries.

13. The apparatus of claim 12, wherein identifying the grouping of related DNS queries from one or more patterns in the historic DNS queries comprises at least one of:
applying a statistical model to the historic DNS queries to identify the one or more patterns; and
identifying a time-based pattern in the grouping of related DNS queries from the historic DNS queries.

14. The apparatus of claim 11, wherein the memory further stores instructions that, when executed by the one or more processors, cause the apparatus to:
use an attribute of an additional DNS query to identify a non-membership of the additional DNS query in the grouping of related DNS queries; and
transmit an additional response to the additional DNS query separately from transmitting the response to the DNS query.

15. The apparatus of claim 11, wherein obtaining the set of DNS records for resolving the related DNS queries comprises at least one of:
obtaining the DNS records from a cache; and
using one or more DNS servers to resolve the grouping of related DNS queries.

16. The apparatus of claim 11, wherein the grouping of related DNS queries is associated with loading of a web page.

17. The apparatus of claim 11, wherein the one or more attributes comprise:
a domain name;
a record type; and
a sender.

18. A system, comprising:
a query-processing module comprising a non-transitory computer-readable medium comprising instructions that, when executed, cause the system to:
use one or more attributes of a Domain Name System (DNS) query to identify a membership of the DNS query in a grouping of related DNS queries;
obtain a set of DNS records for resolving the related DNS queries; and
expedite resolution of subsequent DNS queries in the grouping by transmitting the set of DNS records in a response to the DNS query; and
an analysis module comprising a non-transitory computer-readable medium comprising instructions that, when executed, cause the system to analyze a set of historic DNS queries to identify the grouping of related DNS queries from one or more patterns in the historic DNS queries.

19. The apparatus of claim 18, wherein identifying the grouping of related DNS queries from one or more patterns in the historic DNS queries comprises at least one of:
applying a statistical model to the historic DNS queries to identify the one or more patterns; and
identifying a time-based pattern in the grouping of related DNS queries from the historic DNS queries.

20. The apparatus of claim 18, wherein the one or more attributes comprise:
a domain name;
a record type; and
a sender.
